(19) United States
(12) Patent Application Publication
(10) Pub. No.: US 2024/0239986 A1
(43) Pub. Date: Jul. 18, 2024

(54) COPOLYESTER AND HOT MELT ADHESIVE

(71) Applicant: INDUSTRIAL TECHNOLOGY RESEARCH INSTITUTE, Hsinchu (TW)

(72) Inventors: Che-Tseng LIN, Hsinchu City (TW); Meng-Hsin CHEN, Zhubei City (TW); Jen-Chun CHIU, Zhubei City (TW); Kai-Chuan KUO, Hsinchu City (TW); Yu-Lin CHU, Hsinchu City (TW); Po-Hsien HO, Taipei City (TW); Ke-Hsuan LUO, Hsinchu City (TW); Chih-Hsiang LIN, Hsinchu City (TW); Hui-Ching HSU, Tainan City (TW)

(73) Assignee: INDUSTRIAL TECHNOLOGY RESEARCH INSTITUTE, Hsinchu (TW)

(21) Appl. No.: 18/414,890

(22) Filed: Jan. 17, 2024

Related U.S. Application Data
(60) Provisional application No. 63/439,353, filed on Jan. 17, 2023.

(51) Int. Cl. C08J 11/24; C08G 63/183; C09J 167/02

(52) U.S. Cl. CPC C08J 11/24; C08G 63/183; C09J 167/02; C08J 2367/02

(57) ABSTRACT

A copolyester is formed by copolymerizing a depolymerized polyester and succinic acid. The depolymerized polyester includes depolymerized polyethylene terephthalate (PET), and the depolymerized PET is formed by depolymerizing PET with ethylene glycol. The repeating unit of PET and the succinic acid have a molar ratio of 40:60 to 50:50. The repeating unit of PET and the ethylene glycol have a molar ratio of 100:100 to 100:500. The copolyester has a storage modulus of 1*10⁴ Pa to 1*10⁶ Pa at 80° C. The copolyester can be used in a hot melt adhesive.

### CROSS REFERENCE TO RELATED APPLICATIONS

This application claims the benefit of U.S. Provisional Application No. 63/439,353, filed on Jan. 17, 2023, the entirety of which is/are incorporated by reference herein.

### TECHNICAL FIELD

The technical field relates to a copolyester and a hot melt adhesive.

### BACKGROUND

Most of the synthetic plastics currently being produced are disposable, and about 40% of these plastics are used in packaging. The plastics used in packaging materials have poor degradability, causing serious pollution issues. Using reusable, recyclable, or biodegradable plastic packaging materials has become an international trend. The industry begins to actively develop plastic recycling to reduce waste generation and address the issue of plastic pollution.

Straw glue, bottle labeling, and sealing glue on plastic packaging often cannot be recycled or decomposed (and can only be incinerated) due to residual hot melt adhesive, which is detrimental to the environment and carbon reduction. Accordingly, a novel biodegradable copolyester material is called for to be used in a hot melt adhesive.

### SUMMARY

One embodiment of the disclosure provides a copolyester formed by copolymerizing a depolymerized polyester and succinic acid. The depolymerized polyester comprises a depolymerized polyethylene terephthalate (depolymerized PET). The depolymerized PET is formed by depolymerizing PET with ethylene glycol. The repeating unit of PET and the succinic acid have a molar ratio of 40:60 to 50:50. The repeating unit of PET and the ethylene glycol have a molar ratio of 100:100 to 100:500. The copolyester has a storage modulus of 1*10⁴ Pa to 1*10⁶ Pa at 80° C.

One embodiment of the disclosure provides the described hot melt adhesive, comprising the copolyester.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIG. 1 shows the storage moduli of copolyesters at different temperatures in some embodiments of the disclosure.

FIG. 2 shows the storage moduli of copolyesters at different temperatures in some

embodiments of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

One embodiment of the disclosure provides a copolyester formed by copolymerizing a depolymerized polyester (e.g. monomer or oligomer formed by depolymerizing a polyester) and succinic acid, wherein the depolymerized polyester is formed by depolymerizing polyester with ethylene glycol. In some embodiments, an antimony-based catalyst used in the polymerization process and the depolymerizing process includes antimony(III) acetate, antimony trioxide, antimony ethylene glycol, or the like. If another catalyst other than the antimony-based catalyst is adopted, it will cause several problems. For example, if a titanium-based catalyst is adopted, the formed copolyester will be easily yellowing. If a zinc-based catalyst is adopted, the formed copolyester will have a storage modulus at high temperature that is too low (e.g. being a fluid) and cannot be used in a hot melt adhesive. If a tin-based catalyst is adopted, its toxicity will be too high and may raise concerns about industrial safety. In some embodiments, the repeating unit of polyester (e.g. PET) and the antimony element of the antimony-based catalyst have a weight ratio of 100:0.00085 to 100:0.17. If the amount of the antimony element is too low, the depolymerization will be incomplete, thereby resulting in a poor reactivity of the depolymerized polyester. If the amount of the antimony element is too high, the side reaction such as forming diethylene glycol will be easily catalyzed, thereby decreasing the thermal stability of the copolyester.

In some embodiments, the depolymerized polyester and the succinic acid are firstly esterified and then copolymerized. For example, the esterification can be performed under a normal pressure at a temperature of 200° C. to 230° C. for a period of 1 hour to 3 hours. The copolymerization can be performed under a pressure of 0.1 torr to 3 torr at a temperature of 240° C. to 290° C. for a period of 2 hours to 5 hours. It should be understood that the above conditions of the esterification and copolymerization are only for illustration, and the disclosure is not limited thereto. One skilled in the art may adjust the conditions of the esterification and copolymerization as needed to obtain the copolyester.

In some embodiments, the depolymerized polyester comprises a depolymerized polyethylene glycol (PET), and the depolymerized PET is formed by depolymerizing PET with ethylene glycol. The repeating unit of PET and the ethylene glycol have a molar ratio of 100:100 to 100:500. If the amount of ethylene glycol is too low, the depolymerization will be incomplete, thereby resulting in a poor reactivity of the depolymerized polyester. If the amount of the ethylene glycol is too high, the amount of the repeating unit corresponding to diethylene glycol in the copolyester will be too much, thereby decreasing the thermal stability of the copolyester. In some embodiments, the repeating unit of PET and the succinic acid have a molar ratio of 40:60 to 50:50. If the amount of the succinic acid is too low, the formed copolyester will have a storage modulus at 80° C. that is too high and cannot be applied as a hot melt adhesive. If the amount of the succinic acid is too high, the succinic acid and the depolymerized PET cannot form a copolyester.

In some embodiments, the copolyester has a chemical structure as below:

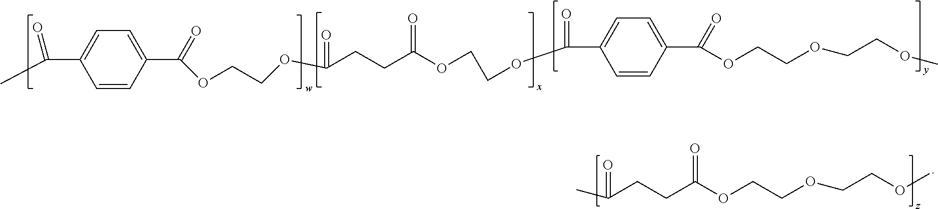

In the above formula, (w+x):(y+z)=99.5:0.5 to 97:3, and (w+y):(x+z)=40:60 to 50:50. If the amount of the repeating unit corresponding to the diethylene glycol (e.g. y+z) is too high, the thermal stability of the copolyester will be decreased. If the amount of the repeating unit corresponding to the succinic acid (e.g. x+z) is too low, the storage modulus of the formed copolyester at 80° C. will be too high to be used in a hot melt adhesive. If the amount of the repeating unit corresponding to the succinic acid (e.g. x+z) is too high, the succinic acid and the depolymerized PET cannot form the copolyester.

In some embodiments, the depolymerized polyester further comprises depolymerized polyethylene isophthalate (PEI), the depolymerized PEI is formed by depolymerizing PEI with the ethylene glycol, and the repeating unit of PET and the repeating unit of PEI have a molar ratio of 99.9:0.1 to 98:2. If the amount of PEI is too high, the structural regularity of the copolyester will be destroyed and the thermal stability of copolyester will be decreased. In this embodiment, the chemical structure of the copolyester may refer the described chemical structure such as

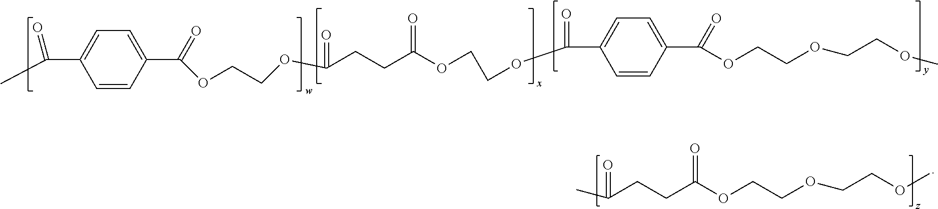

but further includes the repeating units

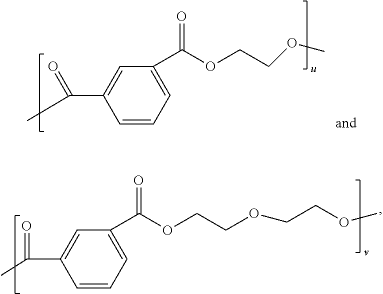

in which (w+x+u):(y+z+v)=99.5:0.5 to 97:3, (w+y+u+v):(x+z)=40:60 to 50:50, and (w+y) : (u+v)=99.9:0.1 to 98:2.

In some embodiments, the copolyester has an intrinsic viscosity of 0.5 dL/g to 2.0 dL/g at 30° C. If the intrinsic viscosity of the copolyester is too low, the thermal resistance and mechanical strength of the copolyester will be poor. If the intrinsic viscosity of the copolyester is too high, the flowability of the copolyester will be too low to wet different materials.

In some embodiments, the copolyester has a storage modulus of 1*10⁴ Pa to 1*10⁶ Pa at 80° C., or 1*104 Pa to 9*10⁵ Pa at 80° C. If the storage modulus of the copolyester at 80° C. is too low, the copolyester used as a hot melt adhesive will easily flow and be difficult to shape (resulting in a thickness that is too thin and a low adhesion strength). If the storage modulus of the copolyester at 80° C. is too high, the copolyester used as a hot melt adhesive will be difficult to adhere to a substrate. In some embodiments, the copolyester has a thermal decomposition temperature (Td, 5%) of 380° C. to 400° C.

One embodiment of the disclosure provides a hot melt adhesive including the described copolyester. In addition, the copolyester may further include another auxiliary agent such as an anti-oxidant, flow promoter, plasticizer, tackifier, or a combination thereof to achieve the desired properties of the hot melt adhesive. Because the copolyester in the disclosure has an excellent biodegradability, viscosity, storage modulus, and thermal stability, it can be used in the hot melt adhesive to address such issues as when the conventional biodegradable material cannot be used in the hot melt adhesive.

Below, exemplary embodiments are described in detail with reference to the accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

In following Examples, the ratios of the repeating units of the copolyester were converted from the integrated values of NMR signals. The thermal decomposition temperature (Td, 5%) of the copolyester was measured according to the ASTM E1131, the intrinsic viscosity of the copolyester at 30° C. was measured according to the standard ASTM D4603, and the storage modulus of the copolyester was measured according to the method disclosed in J. Polym. Sci., 28. 118 (1958).

### Example 1

192 g of recycled PET (rPET, having 1.00 mole of the repeating unit), 124 g of ethylene glycol (EG, 2.00 mole), and 0.08 g of the catalyst antimony(III) acetate (0.00027 mole, including 0.033 g of antimony element) were mixed and then heated to 200° C. under nitrogen to perform a depolymerization reaction for 1 hour. Subsequently, 118 g of succinic acid (SA, 1.00 mole), 0.50 g of anti-oxidant CHEMNOX-1010 (commercially available from Dun-Ho Company), and 0.33 g of anti-oxidant CHEMNOX-168 (commercially available from Dun-Ho Company) were added to the depolymerized PET to perform an esterification reaction, and then heated to 280° C. and evacuated to perform a polymerization reaction for 140 minutes to prepare a copolyester. The copolyester had a chemical structure of

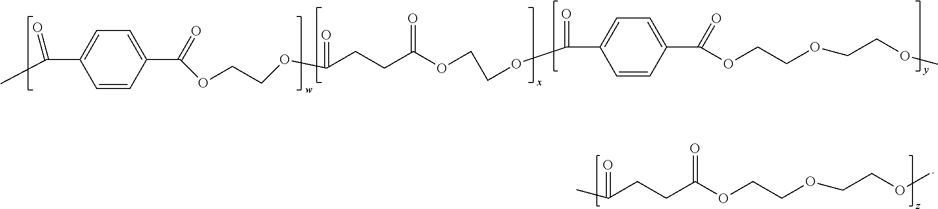

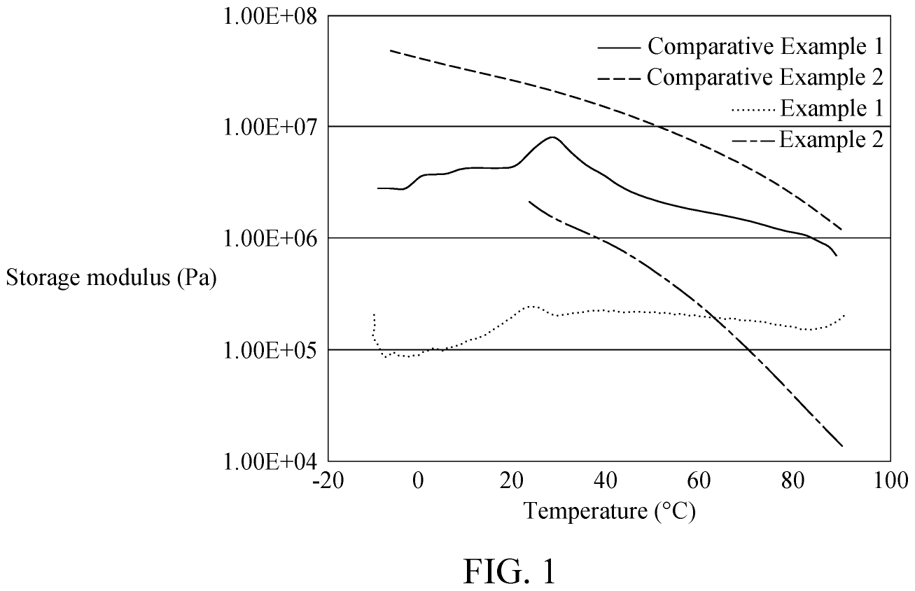

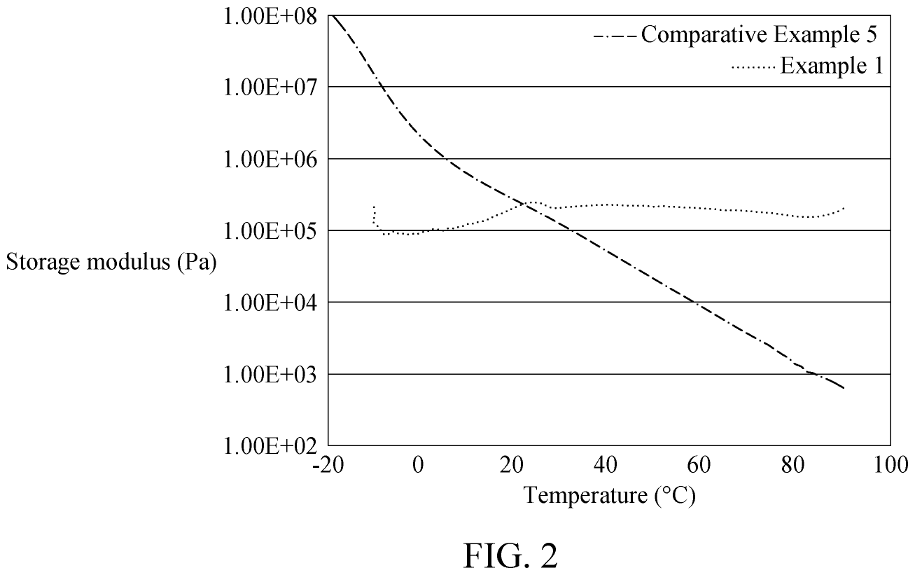

In the above formula, (w+x):(y+z)=98.17:1.83, and (w+y):(x+z)=47.3:52.7. It should be noted from the process that the copolyester was a random copolymer rather than a block copolymer. The copolyester had an intrinsic viscosity of 1.0 dL/g at 30° C. and a thermal decomposition temperature (Td, 5%) of 388° C. The storage modulus of the copolyester at different temperatures was shown in FIGS. 1 and 2. As illustrated in FIGS. 1 and 2, the copolyester had a storage modulus of 1.5*10⁵ Pa at 80° C., which is suitable for use in a hot melt adhesive.

### Example 2

192 g of rPET (having 1.00 mole of the repeating unit), 124 g of EG (2.00 mole), and 0.08 g of the catalyst antimony(III) acetate (0.00027 mole, including 0.033 g of antimony element) were mixed and then heated to 200° C. under nitrogen to perform a depolymerization reaction for 1 hour. Subsequently, 177 g of SA (1.50 mole), 0.53 g of anti-oxidant CHEMNOX-1010 (commercially available from Dun-Ho Company), and 0.35 g of anti-oxidant CHEMNOX-168 (commercially available from Dun-Ho Company) were added to the depolymerized PET to perform an esterification reaction, and then heated to 280° C. and evacuated to perform a polymerization reaction for 180 minutes to prepare a copolyester. The copolyester had a chemical structure that could refer to the structure in Example 1, wherein (w+x):(y+z)=97.52:2.48, and (w+y):(x+z)=38.5:61.5. The copolyester had an intrinsic viscosity of 0.7 dL/g at 30° C. and a thermal decomposition temperature (Td, 5%) of 390° C. The storage modulus of the copolyester at different temperatures was shown in FIG. 1. As illustrated in FIG. 1, the copolyester had a storage modulus of 3.1*10⁴ Pa at 80° C., which is suitable for use in a hot melt adhesive.

### Comparative Example 1

192 g of rPET (having 1.00 mole of the repeating unit), 124 g of EG (2.00 mole), and 0.08 g of the catalyst antimony(III) acetate (0.00027 mole, including 0.033 g of antimony element) were mixed and then heated to 200° C. under nitrogen to perform a depolymerization reaction for 1 hour. Subsequently, 78.5 g of SA (0.67 mole), 0.50 g of anti-oxidant CHEMNOX-1010 (commercially available from Dun-Ho Company), and 0.33 g of anti-oxidant CHEMNOX-168 (commercially available from Dun-Ho Company) were added to the depolymerized PET to perform an esterification reaction, and then heated to 280° C. and evacuated to perform a polymerization reaction for 130 minutes to prepare a copolyester. The copolyester had a chemical structure that could refer to the structure in Example 1, wherein (w+x):(y+z)=97.75:2.25, and (w+y):(x+z)=61.3:38.7. The copolyester had an intrinsic viscosity of 0.97 dL/g at 30° C. and a thermal decomposition temperature (Td, 5%) of 398° C. The storage modulus of the copolyester at different temperatures was shown in FIG. 1. As illustrated in FIG. 1, the copolyester had a storage modulus of 1.1*106 Pa at 80° C., which is not suitable for use in a hot melt adhesive.

### Comparative Example 2

The properties of the copolyester PBAT (C1200, commercially available from BASF) were measured. PBAT had a chemical structure of

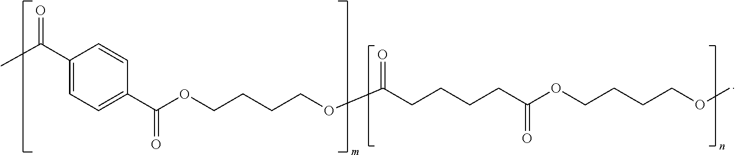

PBAT had an intrinsic viscosity of 0.85 dL/g at 30° C. and a thermal decomposition temperature (Td, 5%) of 371° C. The storage modulus of PBAT at different temperatures was shown in FIG. 1. As illustrated in FIG. 1, PBAT had a storage modulus of 2.2*10⁶ Pa at 80° C., which is not suitable for use in a hot melt adhesive.

### Comparative Example 3

192 g of rPET (having 1.00 mole of the repeating unit), 124 g of EG (2.00 mole), and 0.08 g of the catalyst antimony(III) acetate (0.00027 mole, including 0.033 g of antimony element) were mixed and then heated to 200° C. under nitrogen to perform a depolymerization reaction for 1 hour. Subsequently, 275 g of SA (2.33 mole), 0.50 g of anti-oxidant CHEMNOX-1010 (commercially available from Dun-Ho Company), and 0.33 g of anti-oxidant CHEMNOX-168 (commercially available from Dun-Ho Company) were added to the depolymerized PET to perform an esterification reaction, and then heated to 280° C. and evacuated to perform a polymerization reaction. The reaction had a poor reactivity and could not form a copolyester.

### Comparative Example 4

192 g of rPET (having 1.00 mole of the repeating unit), 372 g of EG (6.00 mole), and 0.08 g of the catalyst antimony(III) acetate (0.00027 mole, including 0.033 g of antimony element) were mixed and then heated to 200° C. under nitrogen to perform a depolymerization reaction for 1 hour. Subsequently, 118 g of SA (1.00 mole), 0.53 g of anti-oxidant CHEMNOX-1010 (commercially available from Dun-Ho Company), and 0.35 g of anti-oxidant CHEMNOX-168 (commercially available from Dun-Ho Company) were added to the depolymerized PET to perform an esterification reaction, and then heated to 280° C. and evacuated to perform a polymerization reaction for 180 minutes to prepare a copolyester. The copolyester had a chemical structure that could refer to the structure in Example 1, wherein (w+x):(y+z)=94.7:5.3, and (w+y):(x+z)=47.6:52.4. The copolyester had an intrinsic viscosity of 1.0 dL/g at 30° C. and a thermal decomposition temperature (Td, 5%) of 375° C. Because the amount of EG was too high, the amount of the repeating unit corresponding to diethylene glycol would be too high, thereby decreasing the thermal stability of the copolyester.

### Comparative Example 5

192 g of rPET (having 1.00 mole of the repeating unit), 124 g of EG (2.00 mole), and 0.08 g of the catalyst zinc acetate (0.00044 mole) were mixed and then heated to 200° C. under nitrogen to perform a depolymerization reaction for 1 hour. Subsequently, 118 g of SA (1.0 mole), 0.53 g of anti-oxidant CHEMNOX-1010 (commercially available from Dun-Ho Company), and 0.35 g of anti-oxidant CHEMNOX-168 (commercially available from Dun-Ho Company) were added to the depolymerized PET to perform an esterification reaction, and then heated to 280° C. and evacuated to perform a polymerization reaction for 180 minutes to prepare a copolyester. The copolyester had a chemical structure that could refer to the structure in Example 1, wherein (w+x):(y+z)=98.1:1.9, and (w+y):(x+z)=47.8:52.2. The copolyester had an intrinsic viscosity of 1.0 dL/g at 30° C. and a thermal decomposition temperature (Td, 5%) of 367° C. The storage modulus of the copolyester at different temperatures was shown in FIG. 2. As illustrated in FIG. 2, the copolyester had a storage modulus of about 1000 Pa at 80° C. When the copolyester was used in a hot melt adhesive, it flowed too fast to shape (e.g. overflow occurred), such that the adhesive thickness was too thin and the adhesion strength was poor. The copolyester formed in the presence of zinc acetate rather than the antimony(III) acetate had a low thermal decomposition temperature and a low storage modulus at high temperature.

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. A copolyester,
formed by copolymerizing a depolymerized polyester and succinic acid,
wherein the depolymerized polyester comprises a depolymerized polyethylene terephthalate (PET), and the depolymerized PET is formed by depolymerizing PET with ethylene glycol,
wherein a repeating unit of PET and the succinic acid have a molar ratio of 40:60 to 50:50,
wherein a repeating unit of PET and the ethylene glycol have a molar ratio of 100:100 to 100:500, and
wherein the copolyester has a storage modulus of 1*10⁴ Pa to 1*10⁶ Pa at 80° C.

2. The copolyester as claimed in claim 1, wherein the depolymerized polyester further comprises depolymerized polyethylene isophthalate (PEI), the depolymerized PEI is formed by depolymerizing PEI with the ethylene glycol, and the repeating unit of PET and a repeating unit of PEI have a molar ratio of 99.9:0.1 to 98:2.

3. The copolyester as claimed in claim 1, wherein the copolyester has an intrinsic viscosity of 0.5 dL/g to 2.0 dL/g at 30° C.

4. The copolyester as claimed in claim 1, wherein the depolymerized polyester and succinic acid are polymerized in the presence of an antimony-based catalyst, and PET and an antimony element of the antimony-based catalyst have a weight ratio of 100:0.00085 to 100:0.17.

5. The copolyester as claimed in claim 1, wherein the copolyester has a thermal decomposition temperature (Td) of 380° C. to 400° C.

6. A hot melt adhesive, comprising the copolyester as claimed in claim 1.

7. The hot melt adhesive as claimed in claim 6, wherein the depolymerized polyester further comprises depolymerized PEL, the depolymerized PEI is formed by depolymerizing PEI with the ethylene glycol, and the repeating unit of PET and a repeating unit of PEI have a molar ratio of 99.9:0.1 to 98:2.
